(19) United States
(12) Patent Application Publication
(10) Pub. No.: US 2015/0111629 A1
(43) Pub. Date: Apr. 23, 2015

(54) PROVIDING COLLECTIVE PLAY IN AN ONLINE GAME

(71) Applicant: DP3 CONSULTING, LLC, Clayton, MO (US)

(72) Inventors: Karl Thomas Sestak, Clayton, MO (US); Joseph Michael Galloway, Clayton, MO (US)

(21) Appl. No.: 14/399,841

(22) PCT Filed: Apr. 25, 2013
(86) PCT No.: PCT/US2013/038256

§ 371 Date: Nov. 7, 2014

Related U.S. Application Data
(63) Continuation of application No. 13/465,470, filed on May 7, 2012, now abandoned.

(51) Int. Cl. G07F 17/32; A63F 13/30

(52) U.S. Cl. CPC G07F 17/3293; A63F 13/30
USPC 463/13; 463/42

(57) ABSTRACT

A system for providing play in a game includes one or more processors and memory configured to represent two or more users as a single player in an online game. The processor(s) and memory are configured to receive input, via one or more networks, from each of the users, the input relating to how the single player is to play the game; and based on the inputs from the users, determine an action by the single player in the game. The system can make collective play possible in a game that is structured by the game provider for play by individuals.

### CROSS-REFERENCE TO RELATED APPLICATION

This application is a PCT International Application of U.S. Non-Provisional patent application Ser. No. 13/465,470 filed May 7, 2012. The entire disclosure of the above application is incorporated herein by reference.

### FIELD

The present disclosure relates to providing collective play in an online game.

### BACKGROUND

This section provides background information related to the present disclosure which is not necessarily prior art.

Online gaming is growing in popularity and provides many different avenues for entertainment. Various kinds of games, including but not limited to card games, strategy games, board games, puzzle games, word games, etc., are available to a player who uses a computer. Some online games are suitable for play, e.g., by a single person. Other online games are suitable for play by multiple people competing against one another.

### SUMMARY

This section provides a general summary of the disclosure, and is not a comprehensive disclosure of its full scope or all of its features.

The present disclosure, in one example embodiment, is directed to a system for providing play in a game. The system includes one or more processors and memory configured to represent two or more users as a single player in an online game. The processor(s) and memory are configured to receive input, via one or more networks, from each of the users, the input relating to how the single player is to play the game; and based on the inputs from the users, determine an action by the single player in the game.

In another implementation, the disclosure is directed to a method of providing play in a game. Two or more users are represented as a single player in a game. Inputs are received from each of the users as to how the single player is to play the game. Based on the inputs from the users, it is determined how the single player is to play the game. The method includes providing input by the single player to the game in accordance with the determining. The method is performed by one or more processors using memory and one or more networks.

In yet another implementation, the disclosure is directed to a system for providing play in a game. One or more processors and memory are configured to interface with a game platform for play of a game; interface with two or more users via one or more networks; represent the users as a single player to play the game; and use inputs from each of the users to determine an action for the single player to take in playing the game.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a system for providing game play in accordance with one implementation of the present disclosure;

FIG. 2 is an illustration of a game display in accordance with one implementation of the present disclosure;

FIG. 3 is a diagram of turns of an individual user and of a group of users in accordance with one implementation of the present disclosure;

FIG. 4 is an illustration of a game display in accordance with one implementation of the present disclosure; and

FIG. 5 is a diagram of a system for providing game play in accordance with one implementation of the present disclosure.

Corresponding reference numerals indicate corresponding parts throughout the several views of the drawings.

### DETAILED DESCRIPTION

Example embodiments will now be described more fully with reference to the accompanying drawings.

The present disclosure, in various implementations, is directed to systems and methods for providing a game. The inventors have observed that many games could be highly entertaining if individuals could play such a game as a group or a team. In one example embodiment, a method of providing play in a game includes representing two or more users as a single player in a game. Inputs as to how the single player is to play the game are received from each of the users. Based on the user inputs, it is determined how the single player is to play the game. Input by the single player is provided to the game in accordance with the determining.

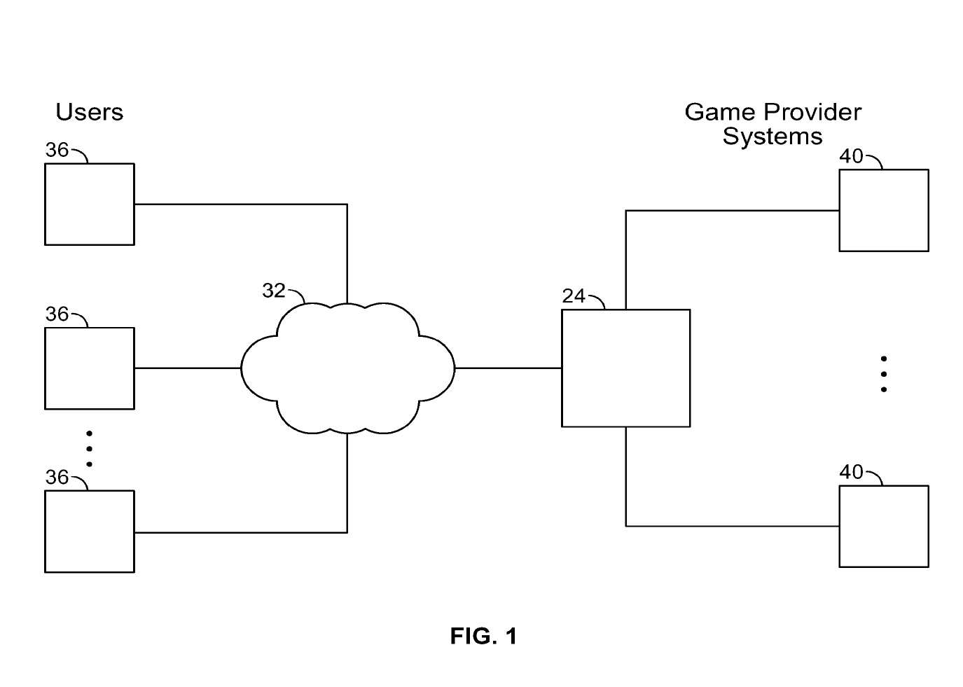

One embodiment of a system for providing game play is indicated generally in FIG. 1 by reference number 20. The system 20 includes a computing system 24 having one or more processors and memory. The computing system 24 may include, e.g., at least one computer, server and/or other device capable of communicating via a network 32 with a plurality of user devices 36 of a plurality of users of the system 20. The computing system 24 and user devices 36 may include various types of processors, memory and/or networking elements, including but not limited to various computers, mobile devices, tablets, servers, routers, storage devices, entertainment devices, gaming systems, smart TVs, etc. The computing system 24 may or may not be distributed among a plurality of devices. It should further be understood that the network 32 may include (without limitation) an internet (e.g., the Internet), an intranet, a cellular network, a satellite network, a cable network, wired and/or wireless networks, etc., and/or combinations of various network types. Those knowledgeable in the art will appreciate that many devices, networks, and combinations thereof are possible in various embodiments of the disclosure.

The computing system 24 is configured to represent two or more users as a single player in an online game. Play in the game may be made available to users through the computing system 24 by a game provider system 40. The game provider system 40 may or may not make the play in the same game available to other users independently of the computing system 24. A plurality of game provider systems 40 may be in communication with the computing system 24. The computing system 24 may provide play in various games from the game provider system(s) 40 to various users via user devices 36. In some embodiments, the computing system 24 may itself act as a game provider system and may provide play in one or more games to users as further described below.

The computing system 24 receives inputs from each of the users associated with a single player via their user devices 36 and the network 32. Specifically and for example, each user votes how the single player is to play the game. Based on the inputs from the users, the computing system 24 determines how the single player is to play the game. The computing system 24 provides input by the single player to the game in accordance with the determining.

Many different games and different types of games may be played by a plurality of users represented by a single virtual player. Although various aspects of the present disclosure are discussed below with reference to a poker game, aspects of the disclosure are not limited to poker, to card games, or to games that are played by a plurality of players. Games may be played that may or may not involve betting by users and/or acquisition and/or loss of stakes, prizes, awards, etc. by users. Such stakes, prizes, and/or awards could be real, virtual, honorary, humorous, of no intrinsic worth, etc. Games may or may not involve the use of a currency, which in various games could be actual, virtual or of no value. In various aspects, games may be played that may or may not involve competition among virtual players. Games may be played, e.g., “against the computer” and/or against combinations of computer(s) and virtual player(s).

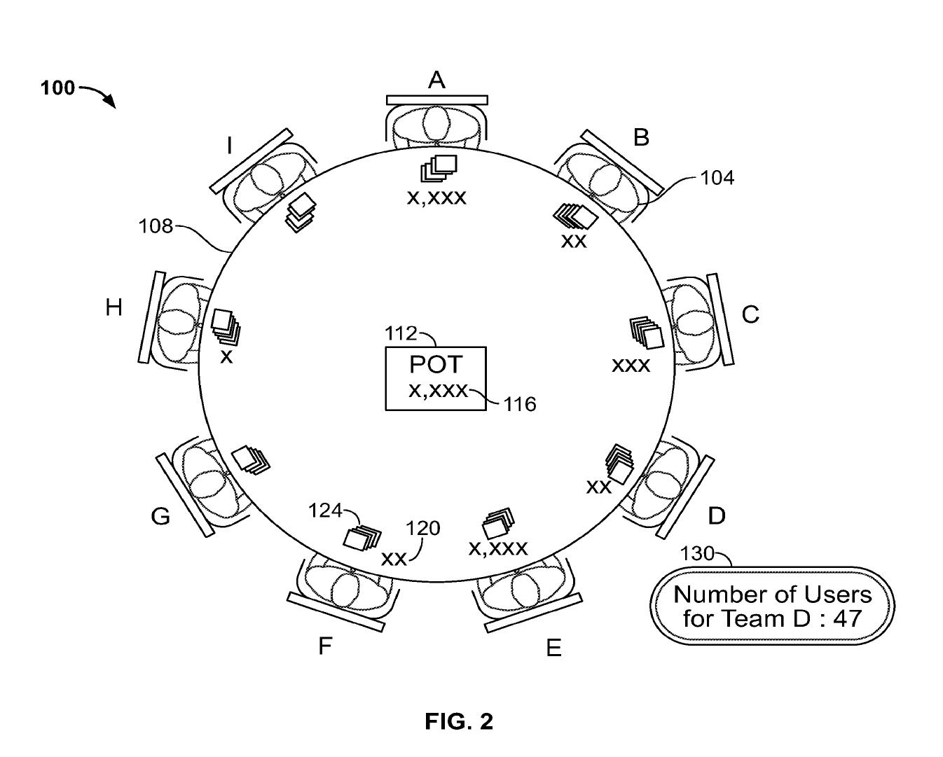

A game display in accordance with one exemplary implementation of the disclosure is indicated generally in FIG. 2 by reference number 100. The display 100 may be provided to user devices 36 by the computing system 24 in communication with the game provider system 40. The display 100 shows a plurality of virtual players 104 representing users participating in a game, e.g., a game of poker provided via the network 32. Each virtual player 104 has a seat at a game table 108. The display 100 shows a pot 112 of chips 116. Numbers 120 of chips bet by each player 104 on a given hand of cards 124 played by one of the players 104 also may be displayed. Play in the game is updated and re-displayed as play proceeds in a predetermined order, e.g., around the table 108.

At least one virtual player 104 represents a group of individual users collectively playing the game, each user using his/her user device 36. Another virtual player 104 may represent an individual user and not a group. Various combinations are possible of virtual players 104 that represent individual users and virtual players 104 that represent groups of users. Each user who is part of a group takes action to play the game individually, in the same or similar manner as if the individual were playing the game as an individual and not as a group member.

When a virtual player 104 that represents a group is given a turn for play, the computing system 24 combines the individual actions of the users on that group to determine an action for that virtual player 104 to take in the game. The computing system 24 sends the action to the game provider system 40 that is providing the game. That action is then played in the game by the game provider system 40 for the given turn of the virtual player 104. The display 100 may include game display information provided by the game provider system 40 and also may display information provided by the computing system 24 specific to a group that receives the display 100. For example, the display 100 may be sent only to users who are currently participating in a group and includes a listing 130 of a number of users who are currently participating in that group. In some embodiments, whether a virtual player 104 represents an individual or a group has little to no bearing on how the game provider system 40 provides the game. Furthermore, in some embodiments the game provider system 40 may have no information as to whether a virtual player 104 represents an individual or a group.

In the example game shown in FIG. 2, each user may contribute money, and/or some other currency that may or may not have value, through the computing system 24 to purchase a chip stack or some other tangible or intangible representation of the user's relative table stakes, for the virtual player 104 representing that user. The computing system 24 may interface with the game providing system 40 to purchase the chip stack. The individual users in the group may subsequently share the virtual player's winnings, if any, e.g., in proportion to their stack contributions.

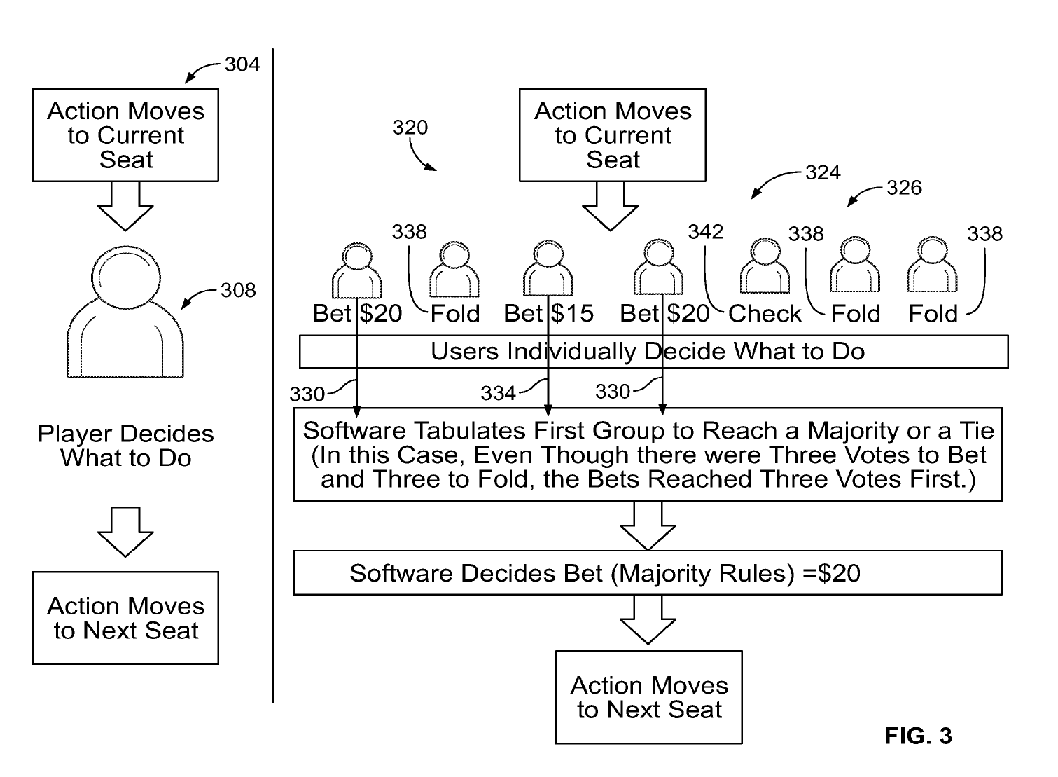

Turns of an individual user and of a group of users in another embodiment of a game, e.g., a poker game, are shown in FIG. 3. For a turn 304 of a virtual player that represents an individual user 308, the user 308 decides what action to take and sends input, e.g., to the game provider system 40, which causes the virtual player representing the user 308 to take that action in the game. Play then passes in the game to another virtual player. For a turn 320 of a virtual player that represents a group 324 of users 326, each user 326 in the group 324 decides what action he/she wishes to take and sends his/her decision to the computing system 24. As shown in FIG. 3, inputs 330 from two users 326 indicate decisions to bet $20. Input 334 from one user 326 indicates a decision to bet $15.Inputs 338 from three users 326 indicate decisions to fold, and one user 326 provides input 342 indicating a decision to check.

The computing system 24 applies one or more rules to reach a collective decision as to how the virtual player for the group 324 is to play the turn. In the example shown in FIG. 3, the computing system 24 identifies a subgroup of users 326 whose votes first reach the computing system 24, e.g., within a predetermined time limit, to produce a majority or a tie. Thus, in the example shown in FIG. 3, where inputs from users 326 who have decided to place a bet reach a majority before inputs from users 326 who have decided to fold, the decisions to bet are used to set the action of the virtual player for the group 324. The computing system 24 next applies a “majority rules” rule to the bets to determine that the virtual player for the group 324 is to make a $20 bet in the game. The decision to bet $20 is transmitted to the game provider system 40, which causes the virtual player for the group 324 to bet $20, and play passes in the game to the next virtual player.

Generally, and with reference to FIG. 1, there are numerous ways in which the computing system 24 may determine an action to be played by a virtual player representing a group. Ways in which an action in a game could be determined may vary dependent on many factors, e.g., on the type of game being played, how many users are playing the game, time factors, whether the game is structured for only one or for more than one virtual player, whether bets are involved, etc. Various methods and/or rules in addition to or in place of “majority rules” and “first to reach majority” could be used to make such determinations. In some games, e.g., averaging and/or even random selection of user inputs might be used to formulate rules.

Referring to the example poker game discussed with reference to FIG. 3, play may proceed alternatively, e.g., as follows. When the sub-group majority decision to bet is reached as described above, the computing system 24 may apply an “averaging” rule to the individual user bets of $20, $20, and $15, rounding any remainder to the next highest dollar, to determine a group bet of $19. The computing system 24 passes this decision to the game provider system 40, which causes the virtual player representing the group 324 to bet $19.

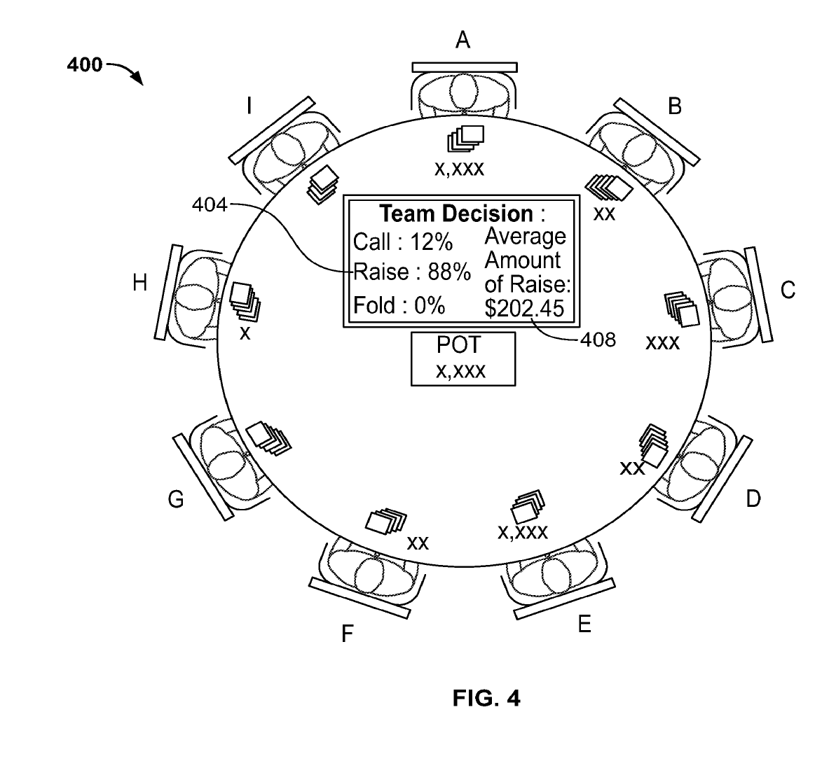

A display of a group decision in the example game referred to with reference to FIG. 2 is indicated generally in FIG. 4 by reference number 400. Upon determining a collective action for a given group to take in a given turn, the computing system 24 may display statistics regarding the determination to users in the group. For example, percentages 404 of users who voted respectively to call, raise, check or fold are displayed, along with an average amount 408 of raises voted by those users voting to raise. Thus a user in a group may be kept current as to how other users in the group are playing turns of the game. The computing system 24 may also allow private conversations among the users in a group, by chat and/or by voice, e.g., to discuss, critique and otherwise collaborate as to the actions and play of the group.

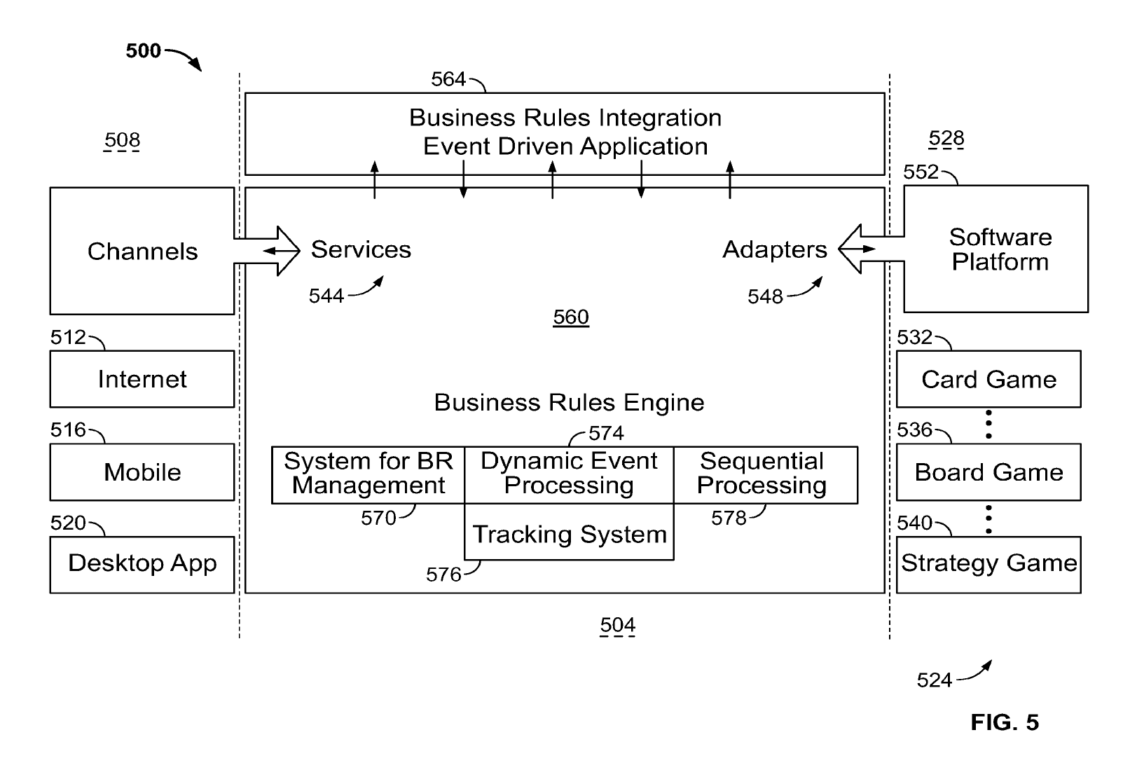

One example configuration of a system for providing play in a game is indicated generally in FIG. 5 by reference number 500. A computing system 504 may be accessed by users over a plurality of channels 508, including but not limited to the Internet 512, mobile network(s) and/or mobile applications 516, and/or desktop applications 520. The computing system 504 may provide users with group play in one or more games 524 provided by a game provider system 528. Such games may include but are not limited to one or more card games 532, one or more board games 536, and/or one or more strategy games 540. The games 524 are examples only, and many different types of games, including but not limited to games (e.g., solitaire) typically playable by only one player, could be made available for group play through the computing system 504. The computing system 504 provides group play, e.g., by providing Web services 544 in a service-oriented environment. Other or additional types of services and/or system architectures could be used, however, to provide game play in other embodiments.

The computing system 504 communicates with the game provider system 528 via one or more application program interface (API) adapters 548 to a software platform 552 of the game provider system 528. One or more APIs, which may or may not be specific to the games 524, may be provided by the game provider system 528 to interface with the computing system 524 through the adapters 548.

The computing system 504 provides group play via a business rules engine 560 in communication with an event-driven application 564. The application 564 may be driven by events in a game 524, e.g., an arrival of a turn to be played by a virtual player representing a group of users. The application also may be driven by group-related events, e.g., receipt of a vote input by a user as to how a group should collectively take an action in the game.

The rules engine 560 includes a system 570 for business rule management, a system 574 for dynamic event processing, a tracking system 576, and a sequential processing system 578. The business rules management system 570 is used to manage rules governing, e.g., the assemblage of a group and of collective actions by a group. Such rules may include, e.g., a maximum number of users who are allowed to be in a group, a “majority rules” rule for tallying user votes, an averaging rule, other or additional tie-breaking and/or tallying rules for determining a collective move, play, amount of a bet or other collective decision for action in a game, etc. The foregoing rules are examples only, and many types of business rules could be provided to handle various aspects of play in various games. The dynamic event processing system 574 may determine that an event detected by the event driven application 564 is governed by one or more of the rules. The tracking system 576 may track user stakes, prizes, awards, etc. relative to stakes, prizes, awards, etc. of a virtual player. Thus, for example, the tracking system 576 may track buy-ins and cash-outs by users relative to winnings and/or losses of a virtual player representing the users. The sequential processing system 578 may keep track, e.g., of previous actions taken by virtual players in the game and/or previous actions taken by users in a group. It should be noted that in some implementations, the computing system 504 may itself exchange events of game play with the event-driven application 564 and business rules engine 560. It also should be noted that system architectures in addition to or alternative to that shown in FIG. 5 may be configured to provide collective play in accordance with various aspects of the present disclosure.

Embodiments of the foregoing system can make collective play possible in a game that is structured by the game provider for play by individuals. Where an adapter is used to interface with the game provider software platform, there is substantially no disruption to the software platform. Thus many different games that are already available for individual play could be made available for collective play by providing appropriate adapters—a small investment compared to the cost of providing an entire gaming system. In various implementations, actions to make game play a collective activity are taken outside an environment in which the game itself takes place. In games where participants become known for their playing skill, many more participants can have an opportunity to play against “top-tier” opponents (where such an opponent could be an individual or another group). For games in which a user pays to play, money can be pooled for a larger buy-in, than if each participant were to play individually. Where the users in a group do not know what the outcome of a group vote on a game action will be, there can be much excitement, anticipation and fun. Users can form teams, e.g., like bowling leagues, play weekly or on some other regular basis, and can maintain standings. New levels of play opportunities are presented when group play is added to an individually played game.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for providing play in a game, the system comprising one or more processors and memory configured to:
represent two or more users as a single player in an online game;
receive input, via one or more networks, from each of the users, the input relating to how the single player is to play the game; and
based on the inputs from the users, determine an action by the single player in the game.

2. The system of claim 1, wherein the one or more processors and memory are configured to provide to the game the action by the single player.

3. The system of claim 2, wherein the one or more processors and memory are configured to use a set of business-decision rules to provide the action by the single player.

4. The system of claim 1, where the game is made available to users represented by a plurality of players.

5. The system of claim 1, where the single player is the only player in the game.

6. The system of claim 1, wherein the one or more processors and memory are configured to interface with a game provider system that provides the online game.

7. A method of providing play in a game, the method comprising:
representing two or more users as a single player in a game;
receiving inputs from each of the users as to how the single player is to play the game;
based on the inputs from the users, determining how the single player is to play the game; and
providing input by the single player to the game in accordance with the determining;
the method performed by one or more processors using memory and one or more networks.

8. The method of claim 7, further comprising providing each of the users with a plurality of options for action in the game for each turn made available to the single player for play in the game.

9. The method of claim 7, wherein at least the determining is performed in accordance with one or more rules.

10. The method of claim 9, wherein the one or more rules include one or more of the following: a “majority rules” rule, an averaging rule, and a “first to reach majority” rule.

11. The method of claim 7, wherein at least the determining is performed in accordance with one or more tie-breaking rules.

12. The method of claim 7, wherein the determining is based at least in part on timing of the inputs from the users.

13. The method of claim 7, wherein:
the inputs from the users include one or more bets; and
the method further comprises making a bet by the single player in the game in accordance with the determining.

14. The method of claim 7, performed using one or more of the following: an internet, a mobile device, and a desktop application.

15. A system for providing play in a game, the system comprising one or more processors and memory configured to:
interface with a game platform for play of a game;
interface with two or more users via one or more networks;
represent the users as a single player to play the game; and
use inputs from each of the users to determine an action for the single player to take in playing the game.

16. The system of claim 15, wherein the action for the single player is determined in accordance with one or more rules for taking into account the inputs from each of the users.

17. The system of claim 16, wherein the game platform is provided by a game provider system.

18. The system of claim 16, further comprising the game platform.

19. The system of claim 16, wherein the interfacing with two or more users is performed using one or more services.

20. The system of claim 16, wherein the game includes poker.
